(19) United States
(12) Patent Application Publication
(10) Pub. No.: US 2026/0326275 A1
(43) Pub. Date: Oct. 22, 2026

(54) SYSTEMS AND METHODS FOR SECURING PHOTOVOLTAIC CLIPS TO FRAME RAILS

(71) Applicant: ARRAY TECH, INC., Albuquerque, NM (US)

(72) Inventors: Benjamin C. DeFresart, Chandler, AZ (US); James Sorensen, Albuquerque, NM (US); Nick Ibis, Phoenix, AZ (US); Kevin Krautbauer, Albuquerque, NM (US); Shuo Chen, Chandler, AZ (US); Nathan Schuknecht, Golden, CO (US)

(21) Appl. No.: 19/649,911

(22) Filed: Apr. 16, 2026

Related U.S. Application Data
(60) Provisional application No. 63/791,280, filed on Apr. 18, 2025.

(51) Int. Cl. B25B 27/14; H02S 30/10

(52) U.S. Cl. CPC B25B 27/146; H02S 30/10

(57) ABSTRACT

Disclosed is an apparatus for facilitating installation of components in a PV system that may include a clip mount configured to selectively retain a PV module clip and a drive mechanism connected to the clip mount. The drive mechanism may be configured to generate and apply a force to the clip mount move the clip mount from a first position in which the PV module clip is in an uninstalled state to a second position in which the PV module clip is in an installed state.

### CROSS-REFERENCE TO RELATED APPLICATIONS

This patent application claims priority to and the benefit of U.S. Provisional Patent Application Ser. No. 63/791,280 file Apr. 18, 2025, which is incorporated by reference in its entirety.

### FIELD OF THE INVENTION

The present disclosure generally relates to systems and methods for securing photovoltaic (PV) clips to frame rails.

### BACKGROUND

Installation of photovoltaic (PV) modules often requires a PV module frame to be secured to an underlying frame rail, which is then mounted on a torque tube or other support structure. A number of different mechanisms may be used to secure a PV module frame to a frame rail. For example, threaded fasteners such as bolts may be inserted through one or more holes in the PV module frame and frame rail. This, however, is time and labor intensive as it often requires physical manipulation of multiple parts, tightening bolts and nuts to a specific torque, and/or quality control checks that must be done on torqued fasteners as part of the installation process.

To avoid the time and labor that threaded fasteners require, clip products that reduce installation time and labor are sometimes used to secure a PV module frame to a frame rail. However, existing clip solutions may be difficult to install and may twist and turn based on the installation technique and the method used to hold the PV module and frame rail together. The difficulty and movement in installation may lead to inconsistent results and improperly installed clips which may, in turn, lead to damaged PV modules and support structures. For example, existing clips may create a lopsided attachment between the PV module and frame rail—e.g., more on one side of the clip than the other—which may lead to twisting of the clip relative to the PV module and/or frame rail. The twisting of the clip relative to the frame rail and/or the PV module frame may lead to inefficient installation or inadequate connection between the PV module frame and the frame rail.

In addition, installing existing clip solutions typically requires repeated mechanical force, which is commonly applied using a hammer, slide hammer, press tool, ratcheting mechanism, or other impact-based or leverage-driven devices designed to secure the PV clip. In many instances, manually applying force to these clips leads to inconsistent results that may depend, for example, on the installer or the device applying the force. In some instances, these inconsistencies may result in inconsistent PV clip installation, broken PV clips, as well as damage to PV module frames, torque tubes, and/or frame rails. Further, the task of manually installing PV clips is fatiguing and repetitive. This is particularly true in large-scale solar installations (e.g., utility-scale solar installations) where, in some instances, hundreds or thousands of PV clips are installed in a solar field.

The subject matter claimed in the present disclosure is not limited to embodiments that solve any disadvantages or that operate only in environments such as those described above.

Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address problems experienced in conventional solar panel tracking systems, including problems associated with the installation and use of clips to secure a PV module to a frame rail. Embodiments disclosed herein address this issue by providing an apparatus that may provide consistent and, in some instances automatic, installation of PV clips to PV module frames and/or frame rails. In some embodiments, the apparatus includes one or more portions that may be configured to receive and/or attach to the PV clip in a pre-installed state. These portions—together or separately—may be referred to herein as a clip mount, where the clip mount may attach to the PV module clip in a pre-installed state. Further, embodiments of the present disclosure may include a force application mechanism that may be designed to transfer force to the clip mount and, by extension, the PV module clip. The force applied using the force application mechanism is created to enable the installation of the PV module clip on a combination of the PV module rail and a frame rail. In addition, embodiments may include a force application mechanism, the clip mount, and/or PV module clip. The combination of the clip mount, the force application mechanism may help to facilitate consistent installation of PV module clips, decrease fatigue among installers, and increase the speed with which PV module clips may be installed.

In one embodiment, an apparatus for facilitating installation of components in a PV system may include a clip mount configured to selectively retain a PV module clip and a drive mechanism connected to the clip mount. The drive mechanism may be configured to generate and apply a force to the clip mount move the clip mount from a first position in which the PV module clip is in an uninstalled state to a second position in which the PV module clip is in an installed state.

In some embodiments, the drive mechanism may include a fluid driven system. In these embodiments, the fluid driven system may be a hydraulic or pneumatic system.

In some embodiments, the drive mechanism may include an electrically driven system. In these embodiments, the electric driven system may be an electric motor.

In some embodiments, the drive mechanism may include a mechanically driven system.

In some embodiments, the force may be applied to the clip mount by the drive mechanism through a linear actuator.

In some embodiments, the force may be applied to the clip mount by the drive mechanism through a solenoid-based actuator.

In some embodiments, the clip mount may be configured to selectively retain the PV module clip through a friction or magnetic attachment.

In some embodiments, the apparatus may include an elongated shaft configured to transmit the force from the drive mechanism to the clip mount.

In some embodiments, the apparatus may include a first actuator for activating the drive mechanism to move the clip mount from the first position to the second position and a second actuator for activating the drive mechanism to move the clip from the second position to the first position.

In some embodiments, the clip mount may have an external shape that corresponds to an interior geometry of the PV module clip. In these embodiments, the clip mount may define a slot configured to receive one or more components of the PV system during an installation operation.

In some embodiments, the apparatus may include a force reaction arm configured to provide a counter force to the force applied to the clip mount during an installation operation. In these embodiments, the clip mount may be a first clip mount and the force reaction arm may include a second clip mount configured to selectively retain a second PV module clip. In these embodiments, a distance between the first and second clip mounts may be selectively adjustable.

In some embodiments, the clip mount may include a strip configured to selectively retain a plurality of PV module clips. In these embodiments, the clip mount may include a feeding mechanism that automatically advances the PV module clips within the plurality of module clips after installation operations.

In another embodiment, an apparatus for facilitating installation of components in a PV system may include an impact tool configured to generate repeated impact forces. The impact tool may include at least one of a rotary hammer, a percussion mechanism, a solenoid impact mechanism, a cam-based impact mechanism, a spring-loaded impact mechanism, a hydraulic impact mechanism, or a pneumatic impact mechanism. The apparatus may also include a clip mount configured to selectively retain a PV module clip and a force transmitting shaft configured to transmit the impact forces from the impact tool to the clip mount to move the clip mount from a first position in which the PV module clip is in an uninstalled state to a second position in which the PV module clip is in an installed state.

In another embodiment, an apparatus for facilitating installation of components in a PV system may include a clip mount configured to selectively retain a PV module clip and a drive mechanism configured to generate and apply a linear force to the clip mount. The drive mechanism may comprise a pneumatic, hydraulic, or electric motor. The apparatus may further include a force reaction arm configured to provide a counter force to the linear force applied to the clip mount during an installation operation.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the accompanying drawings in which:

FIG. 1 illustrates an exemplary system for securing PV modules and to a mounting rail using clips;

FIG. 2 illustrate an example clip and its interaction with components shown in FIG. 1;

FIG. 3 illustrates an example clip which is an alternative design of the clip described and illustrated with respect to FIG. 2;

FIG. 4 illustrate another embodiment illustrating an example clip, which is another alternative design of the clip described and illustrated with respect to FIG. 2;

FIGS. 5A-5C illustrate various views of an example embodiment of a PV clip installation tool and its interactions with the clip described and/or illustrated with respect to FIGS. 1 and 2;

FIGS. 6A-6D illustrate various views of an example embodiment of a PV clip adapter for use in a PV installation tool and its interactions with the clip described and/or illustrated with respect to FIGS. 1 and 2;

FIGS. 7A-7B illustrates a clip installation tool including multiple clip attachment arms for installing multiple clips described and/or illustrated with respect to FIGS. 1 and 2;

FIGS. 8A-8B illustrate various views of an example embodiment of a PV clip installation tool that may utilize a drive mechanism for installing the clip described and/or illustrated with respect to FIGS. 1 and 2;

FIGS. 9A-9B show various views illustrating an embodiment of a PV clip installation tool and its interactions with the clip described and/or illustrated with respect to FIGS. 1 and 2;

FIG. 10 illustrates an embodiment of a PV clip installation tool configured to install multiple clips sequentially from a strip of clips described and/or illustrated with respect to FIGS. 1 and 2;

all in accordance with one or more embodiments in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

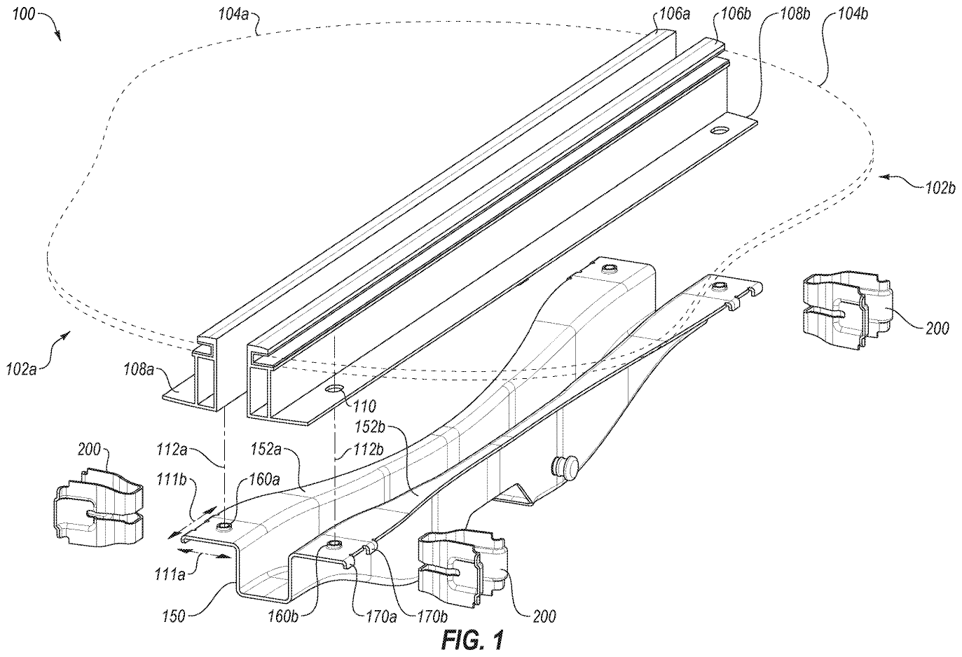

FIG. 1 illustrates an exemplary system 100 for securing PV modules 102a and 102b to a mounting rail 150 using clips 200. The first PV module 102a includes a first solar panel 104a and a first frame 106a that is secured to an edge of the first solar panel 104a. The first frame 106a includes a first frame rail flange 108a that lies on a plane that is generally parallel to the plane on which the first solar panel 104a lies. The second PV module 102b includes a second solar panel 104b and a second frame 106b that is secured to an edge of the second solar panel 104b. The second frame 106b includes a second frame rail flange 108b that lies on a plane that is generally parallel to the plane on which the second solar panel 104b lies. The second frame rail flange 108b also includes an aperture 110 (the first and second frame rail flanges 108a and 108b may be referred to generally as “frame rail flange 108”).

The mounting rail 150 includes one or more mounting rail flanges 152—e.g., a first and second mounting rail flange 152a and 152b. An upper surface of the first mounting rail flange 152a is configured to interface with a bottom surface of the first frame rail flange 108a to support the first PV module 102a. The first and second mounting rail flanges 152a and 152b include module locating features 160—e.g., the first module locating feature 160a and the second module locating feature 160b. The first and second module locating features 160a and 160b include protrusions that extend from the upper surface of the first and second mounting rail flanges 152a and 152b. The shapes of these protrusions may be configured to fit within the apertures 110 of the first and second frame rail flanges 108a and 108b such that during an installation procedure, the module locating features 160 may fit within the apertures 110. This may be accomplished by lowering the first and second PV modules 102a and 102b down onto the mounting rail 150 or raising the mounting rail 150 up as shown by the dashed lines 112a and 112b.

The first and second mounting rail flanges 152a and 152b also include clip retention tabs 170 (e.g., a first clip retention tab 170a and a second clip retention tab 170b). The first and second clip retention tabs 170a and 170b include protrusions that extend from a side surface of the first and second mounting rail flanges 152a and 152b. In some embodiments, the first and second clip retention tabs 170a and 170b may be configured to engage with one or more portions of the clip 200. In some embodiments, the first and second clip retention tabs 170a and 170b may be configured to secure the clip 200 to the PV module rail 108 and/or the mounting rail 150. In some embodiments, the clip retention tabs 170a and 170b prevent or limit the clip 200 from slipping relative to the mounting rail 150 after installation. Stated differently, the clip retention tabs 170a and 170b secure the clip 200 in place to enable the connection between the first and second PV modules 102a and 102b to the mounting rail 150.

Thus, in FIG. 1, the clip or clips 200 secure the first and second PV modules 102a and 102b to the mounting rail 150. The module locating features 160 together with corresponding apertures 110 ensure that the first and second PV modules 102a and 102b are aligned properly on the mounting rail 150 and do not slip, or limit an amount that the mounting rail 150 and the first and second PV modules 102a and 102b slip, relative to each other. In addition, the first and second clip retention tabs 170a and 170b decrease or limit an amount that the clip or clips 200 slip or disengage from their positions securing the first and second PV modules 102a and 102b to the mounting rail 150.

Modifications, additions, or omissions may be made to the system 100 without departing from the scope of the disclosure. For example, another system for securing PV modules to a mounting rail, a PV module may lack a flange but may include another structure that may be used to secure the PV module to a mounting rail. In some embodiments, the clip 200 may not be secured using one or more clip retention tabs 170. In some embodiments, the clip 200 may be held in place by the compression force applied by the clip 200 to the mounting rail flange 152 and/or the frame rail flange 108. In addition, the designations of different elements in the manner described is meant to help explain concepts described herein and is not limiting. Further, the system 100 may include any number of other elements or may be implemented within other systems or contexts than those described.

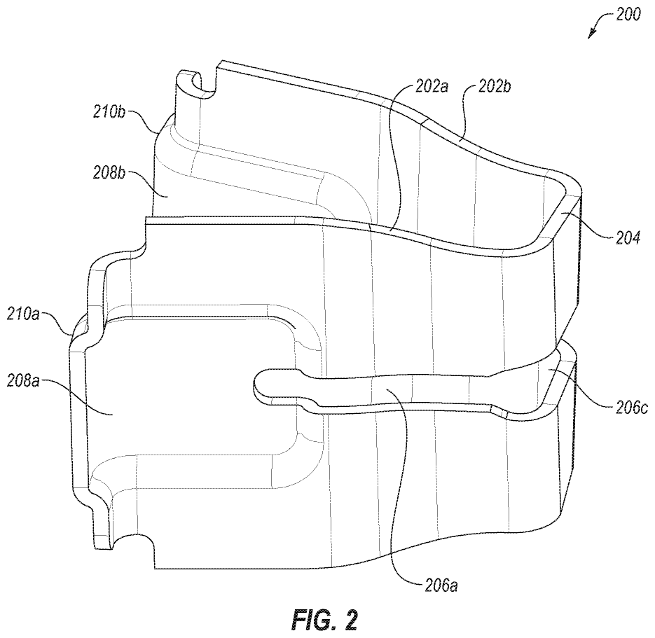

FIG. 2 illustrates an example clip 200 shown in FIG. 1. As shown in FIG. 2, the clip 200 includes a first arm 202a, a second arm 202b, and a connecting body 204. The first and second arms 202a and 202b each include proximal and distal ends. The connecting body 204 connects the proximal ends of the first and second arms 202a and 202b and the distal ends of the first and second arms 202a and 202b extend away from the connecting body 204.

In addition, a slot 206 is defined by a combination of the first arm 202a, the second arm 202b, and the connecting body 204. The slot 206 may extend from the connecting body 204 and the proximal ends of the first and second arms 202a and 202b through to the middle of the first and second arms 202a and 202b. In some embodiments, the slot 206 includes a larger slot portion 206c defined by the connecting body 204 and/or the proximal ends of the first and second arms 202a and 202b. The larger portion 206c may be defined as larger compared to other portions of the slot 206. For example, and as shown in FIG. 2A, the larger slot portion 206c may include a slot defined by a greater space between a top edge and a bottom edge of the slot 206 as compared to a distance between the top edge and the bottom edge of another portion of the slot 206—e.g., a portion of the slot 206 defined by the first or second arms 202a or 202b. In some embodiments, the larger slot portion 206c may be used to place or center the clip 200 on the mounting rail flange 152 and the frame rail flange 108 prior to installing the clip 200.

In some embodiments, the larger portion of the slot 206c may be larger than the combined thicknesses of the mounting rail flange 152 and the frame rail flange 108. As such, the larger slot portion 206c may be used to center and place the clip 200 prior to the clip 200 applying any compression force on the mounting rail flange 152 and/or the frame rail flange 108. As such, in some embodiments, the larger slot portion 206c may allow installers to place and install the clips 200 more consistently and accurately as compared to a clip 200 with a slot 206 that does not include the larger slot portion 206c.

In some embodiments, the slot 206 may extend any distance from the proximal ends to the distal ends of the first and second arms 202a and 202b. As shown in FIG. 2, the slot 206 extends through the proximal ends of the first and second arms 202a and 202b and partially through the first and second retention recesses 208a and 208b included in the first and second arms 202a and 202b, respectively. In some embodiments, a length of the slot 206 along the first and second arms 202a and 202b may be as long as necessary for the clip retention tabs 170 to engage the first and second retention recesses 208a and 208b.

In some embodiments, the first and second retention recesses 208a and 208b may be configured to interface with the clip retention tabs 170 (e.g., the first and second clip retention tabs 170a and 170b) such that the clip 200 may not slip laterally relative to the mounting rail flange 152. In some embodiments, the first and second clip retention tabs 170a and 170b may protrude outward and turn downward relative to the mounting rail flange 152. The turn downward may help to engage the clips 200 and/or the corresponding first and second retention recesses 208a and 208b. In some embodiments, the turn downward may prevent the clips 200 from dislodging or disengaging and moving outward relative to the frame rail flange 108 and/or the mounting rail flange 152. For example, the clip 200 may engage the first mounting rail flange 152a and the first frame rail flange 108a. The first clip retention tab 170a may engage the first retention recess 208a. The first arm 202a of the clip 200 pushes outward applying an expansion force against the first retention tab 170a. The first retention tab 170a applies a corresponding compression force. In some embodiments, the first retention tab 170a may include a downward bend to engage the first retention recess 208a outside of the slot 206. Further, the first clip retention tab 170a extends over a lip corresponding to the first retention recess 208a which may reduce slipping or twisting of the clip 200 relative to the first mounting rail flange 152a and/or the frame rail flange 108a.

In some instances, to install the clip 200, the clip 200 is moved such that the first frame rail flange 108a and the first mounting rail flange 152a are positioned within the slot 206. The first and second retention tabs 170a and 170b slide alongside the slot 206 and into the first and second retention recesses 208a and 208b. Sliding the clip 200 relative to the first and second retention tabs 170a and 170b may cause the clip 200 to flex such that the first and second arms 202a and 202b move inward toward each other. Moving the first and second arms 202a and 202b inward toward each other causes an expansion force applied from the first and second arms 202a and 202b to the clip retention tabs 170a and 170b which assists in keeping the clip 200 in place when properly installed with the clip retention tabs 170a and 170b.

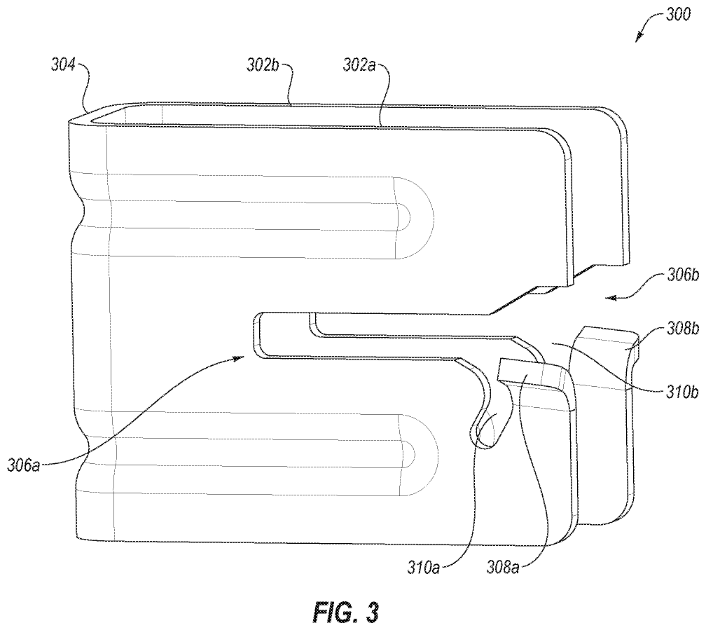

In some embodiments, the first and second arms 202a and 202b may be compressed, flexed, or otherwise moved inward relative to each other using one or more tools or other methods such as those described, for example, with respect to FIGS. 3A-3C. In some embodiments, compressing the first and second arms 202a and 202b toward each other may allow for unobstructed or less obstructed sliding of the clip 200 relative to the first and second retention tabs 170a and 170b. In some embodiments, the compression force applied to the first and second arms 202a and 202b may be released once the first and second retention tabs 170a and 170b are aligned with the first and second retention recesses 208a and 208b. In response, the first and second retention recesses 208a and 208b may interface with the first and second retention tabs 170a and 170b such that the first and second arms 202a and 202b apply an expansion force to the clip retention tabs 170.

During installation of the clip 200, first and second arms 202a and 202b slide past the lateral clip retention tabs 170. Once installed, the lateral clip retention tabs 170 prevent the clip 200 from moving laterally relative to the mounting rail 150, as outside or exterior surfaces of the first and second arms 202a and 202b contact the lateral clip retention tabs 170.

In some embodiments, the clip 200 includes a first clip flange 210a and a second clip flange 210b positioned at the distal ends of the first and second arms 202a and 202b, respectively. In some embodiments, and as shown in FIG. 2, the clip flanges 210 may bend outward relative to a center axis of the clip 200. The first and second clip flanges 210a and 210b may bend outward such that the first and second clip flanges 210a and 210b may be generally parallel to the first mounting rail flange 152 and/or the frame rail flange 108a. In some embodiments, the first and second clip flanges 210a and 210b may be used for one or more installation tools-such as those described with respect to FIGS. 3A-8. For example, the first and second clip flanges 210a and 210b may provide surfaces that may be struck with a mallet or a hammer to facilitate the installation of the clip 200. Additionally or alternatively, the first and second clip flanges 210a and 210b may provide surfaces that may be gripped by one or more tools to compress the first and second arms 202a and 202b together during installation such that, upon release, the first and second arms 202a and 202b may expand and apply an expansion force on, for example, the first and second clip retention tabs 170a and 170b thereby holding the clip 200 in place or reducing lateral movement of the clip 200, in an engaged state. Additionally or alternatively, the first and second clip flanges 210a and 210b may provide surfaces on which pressure or other forces may be applied to slide the clip 200 onto the combination of the mounting rail flange 152 and the frame rail flange 108.

FIG. 3 illustrates an example clip 300 which is an alternative design of the clip 200 described and illustrated with respect to FIG. 2. As shown in FIG. 3, the clip 300 includes a first arm 302a, a second arm 302b, and a connecting body 304. A first slot 306a is defined by the first arm 302a. A second slot 306b is defined by the second arm 302b. Retention tabs 308a and 308b are positioned at the ends of the first and second arms 302a and 302b just within the first and second slots 306a and 306b. Recesses 310a and 310b are positioned directly behind the retention tabs 308a and 308b. Alternative embodiments of a clip may lack these recesses. In some embodiments, clip 300 may be installed by pushing the clip 300 onto the combination of the mounting rail flange 152 and the frame rail flange 108. In some embodiments, the mounting rail flange 152 and the frame rail flange 108 may include one or more other features, protrusions, locking mechanisms, etc. that may be configured to lock the clip 300 in place, much like, for example, the retention tabs 170 described and/or illustrated further in the present disclosure such as, for example, with respect to FIG. 1.

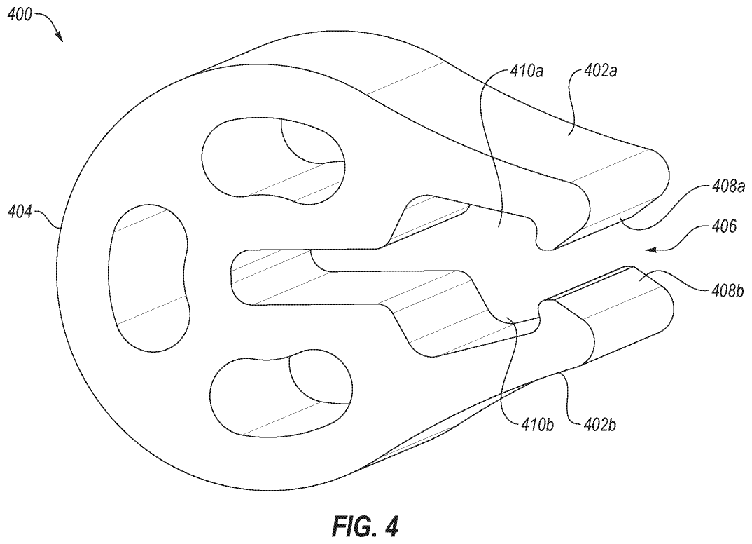

FIG. 4 illustrate another embodiment illustrating an example clip 400. As shown in FIG. 4, the clip 400 includes a top arm 402a, a bottom arm 402b, and a connecting body 404. A slot 406 is defined between the top arm 402a and the bottom arm 402b. Retention tabs 408a and 408b are positioned at the ends of the top and/or bottom arms 402a and 402b that extend inward into the slot 406. Recesses 410a and 410b are positioned directly behind the retention tabs 408a and 408b. In some embodiments, clip 400 may be installed by pushing the clip 400 onto the combination of the mounting rail flange 152 and the frame rail flange 108. In some embodiments, the mounting rail flange 152 and the frame rail flange 108 may include one or more other features, protrusions, locking mechanisms, etc. that may be configured to lock the clip 400 in place, much like, for example, the retention tabs 170 described and/or illustrated further in the present disclosure such as, for example, with respect to FIG. 1.

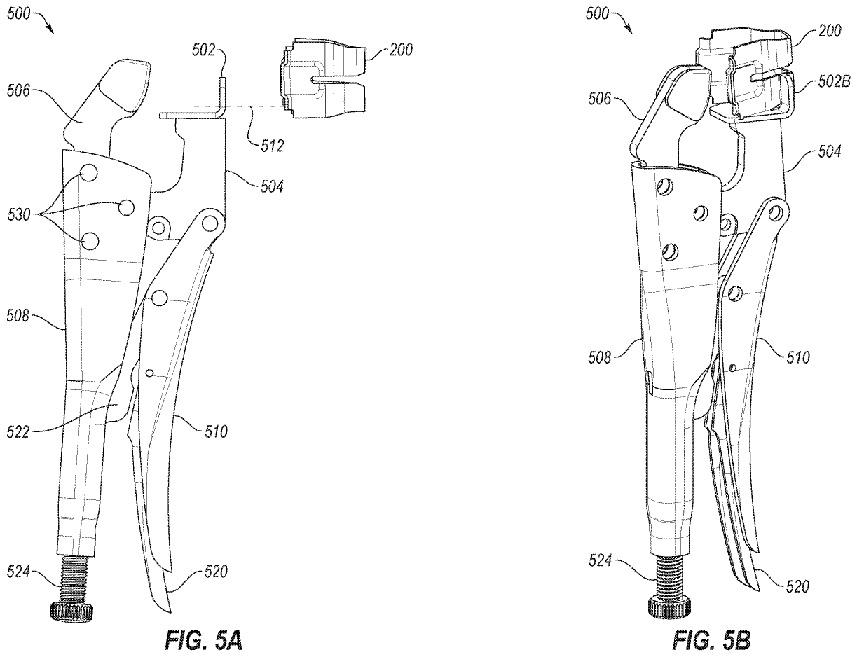

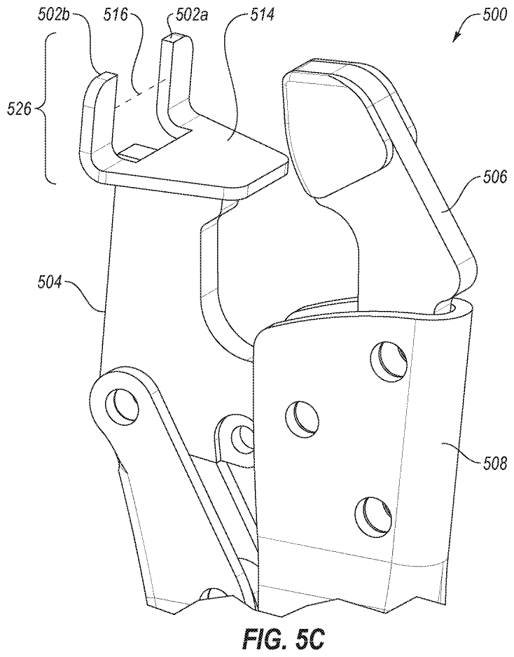

FIGS. 5A-5C illustrate various views of an example embodiment of a PV clip installation tool 500 and its interactions with the clip 200 described and/or illustrated with respect to FIGS. 1 and 2. The clip installation tool 500 includes a fixed arm 508, a lever arm 510, a pivot jaw 504, and a fixed jaw 506. While FIGS. 5A-5C illustrate the PV clip installation tool 500 with respect to the clip 200, one or more other clips such as, for example, the clips 300 and 400 described and/or illustrated further in FIGS. 3-4 may also be used with the same and/or similar tools described with respect to FIGS. 5A-5C.

The fixed arm 508 may be a rigid component of the clip installation tool 500 such that the fixed arm 508 may not move relative to, for example, movement of the lever arm 510. In some embodiments, the fixed arm 508 may be constructed from durable materials such as metal, reinforced plastic, or composite materials that may be designed to withstand the forces applied to the fixed arm 508 during installation operations associated with the clips 200.

In some embodiments, the fixed arm 508 may include one or more apertures, recesses, or attachment points that may help to facilitate the connection of additional components or accessories to the fixed arm 508. For example, the fixed arm 508 may include one or more attaching locations 530 that may define one or more corresponding apertures that may serve as locations of attachment for the lever arm 510, the fixed jaw 506, and/or the pivot jaw 504. In some embodiments, the position, size, and shape of the attaching locations 530 may vary based on the needs of the PV clip installation tool 500 or installation operations. For example, the attaching locations 530 may define apertures that are further apart from each other on the fixed arm 508 than those shown in FIGS. 5A-5C. Continuing the example, by defining apertures further apart, the PV clip installation tool 500 may be configured to accommodate larger clips 200. In some instances, increasing the spacing between apertures defined at attaching locations 530, the clip installation tool 500 may be adapted for securing oversized or non-standard clips while maintaining alignment and gripping force.

In some embodiments, the fixed arm 508 may be configured to house one or more internal components, such as springs, locking mechanisms, or adjustment features, that may contribute to the overall operation of the clip installation tool 500. In some embodiments, the one or more internal components may facilitate controlled movement, secure positioning, or force distribution during installation operations for the clips 200. For example, as shown in FIGS. 5A-5C, the clip installation tool 500 includes an adjustable lever 522, which may be configured to move or adjust relative to the fixed arm 508. The adjustable lever 522 may serve to regulate the spacing and force applied by the clip installation tool 500, which may allow for increased precision and control during installation processes for the clips 200.

In some embodiments, adjusting the adjustable lever 522 may cause the lever arm and/or the pivot jaw 504 to move or lock into place at a greater distance from the fixed jaw 506. In some embodiments, adjusting the adjustable lever 522 may enable the fixed jaw 506 and the pivot jaw 504 to accommodate larger clips 200 and/or other objects positioned between them while maintaining a firm grip—e.g., a grip that secures the clips 200 without allowing the clips 200 to slip or otherwise fall out of position.

In some embodiments, the adjustable lever 522 may be adjusted using a threaded bolt 524. The threaded bolt 524 may be designed to tighten or loosen by engaging internal threads within the fixed arm 508, thereby enabling the adjustable lever 522 to move up or down relative to the fixed arm 508. In some embodiments, the threaded bolt 524 may provide incremental control, allowing an operator to fine-tune the positioning of the adjustable lever 522 and, by extension, the pivot jaw 504. In some embodiments, the threaded bolt 524 may include a locking feature, such as a tensioning nut to prevent unintentional movement and ensure stability during use. Additionally or alternatively, the fixed arm 508 may incorporate reinforced threading or a self-lubricating insert to decrease wear and extend a lifespan associated with the clip installation tool 500.

In some embodiments, adjusting the adjustable lever 522 may be performed using one or more other mechanisms. For example, instead of and/or in connection with the threaded bolt 524, a ratcheting mechanism with predefined notches or detents may allow incremental adjustments while preventing unintentional loosening. Additionally or alternatively, a cam-lock system may be used to make adjustments by rotating a cam lever to engage or release tension.

Additionally or alternatively, one or more hydraulic and/or pneumatic actuators may also be used to provide precise, force-controlled adjustments, among other such examples.

The lever arm 510 includes a movable component of the clip installation tool 500 that may be designed to pivot or rotate relative to the fixed arm 508. In some embodiments, the lever arm 510 may be constructed from durable materials similar to those used for the fixed arm 508, such as metal, reinforced plastic, or composite materials that may withstand repeated use and applied forces during installation operations. In some embodiments, the lever arm 510 may incorporate a textured surface pattern or rubberized coating to improve grip security during operation.

In some embodiments, the lever arm 510 may be mechanically connected to the pivot jaw 504 such that movement of the lever arm 510 may translate, directly or indirectly, to movement of the pivot jaw 504. In some instances, squeezing the lever arm 510 toward the fixed arm 508 may move the pivot jaw 504 closer to the fixed jaw 506, which may create a compression force on any object positioned between the fixed jaw 506 and the pivot jaw 504—e.g., the clips 200, 300, or 400. In some instances, the compression created by the movement of the lever arm 510 relative to the fixed arm 508 may allow the clip installation tool 500 to firmly grip and manipulate the clips 200 during installation operations and procedures.

The clip installation tool 500 may include a locking mechanism 520 that may be configured to secure the lever arm 510 in a fixed position relative to the fixed arm 508. In some embodiments, the locking mechanism 520 may function by engaging a series of teeth, notches, or other mechanical features that may prevent the lever arm 510 from moving once the desired position may be achieved. In some embodiments, locking capability may allow the clip installation tool 500 to maintain consistent pressure on the clips 200 without requiring continuous hand force from the operator.

In some embodiments, the locking mechanism 520 may include a release trigger, lever, button, or other similar mechanism that, when activated, may disengage the locking feature and allow the lever arm 510 to move freely again. In some embodiments, the quick-release functionality may enable rapid repositioning or removal of the clip installation tool 500 after the clips 200 may be successfully installed. The locking mechanism 520 may also incorporate adjustable tension settings that may allow users to customize the amount of force applied to the clips 200 based on specific installation requirements or sizes corresponding to the clips 200, for example.

The fixed jaw 506 and the pivot jaw 504 may function together as the primary gripping components of the clip installation tool 500. The fixed jaw 506 may be rigidly attached to the fixed arm 508, maintaining a stationary position during operation of the clip installation tool 500. In contrast, the pivot jaw 504 may be mechanically connected to the lever arm 510, which may allow the pivot jaw 504 to move in relation to the fixed jaw 506 in response to movement of the lever arm 510. This arrangement may create a variable space between the jaws that may be adjusted to accommodate the clips 200 during installation procedures.

The fixed jaw 506 may be attached to the fixed arm 508, maintaining a stationary position during operation of the clip installation tool 500. In some embodiments, the fixed jaw 506 may be integrally formed with the fixed arm 508. In some embodiments, the fixed jaw 506 may be configured to engage with the clips 200 during installation. In some embodiments, the fixed jaw 506 may be designed to apply pressure to specific points on the clips 200, which may help to engage the clips 200 with the pivot jaw 504.

In some embodiments, the fixed jaw 506 may be configured to engage with the clips 200 for example, the clip flanges 210 to evenly apply force to push the clip 200 against the pivot jaw 504. In instances where the clip 200 is engaged, the fixed jaw 506 and the pivot jaw 504 work in coordination to apply a controlled compression force.

As shown in FIG. 5C, the pivot jaw 506 includes a clip mount 526 configured to receive and/or retain the clip 200 in a pre-installed state. The clip mount 526 of the pivot jaw 506 includes a platform 514 that is connected or otherwise attached to the first and second clip retaining members 502.

The platform 514 may include a flat or substantially flat or planar surface that may be configured to seat the clip 200. Additionally or alternatively, the platform 514 may be angled either toward the clip retaining members 502 or toward the fixed jaw 506. In some embodiments, angling the platform 514 toward the clip retaining members 502 may help to hold the clip 200 in place relative to the clip retaining members 502 even in instances where the fixed jaw 506 and the pivot jaw 504 may not be pushed together in an engaged state.

In some embodiments, the platform 514 may include a width that may accommodate the size of the clip 200. For example, the width of the platform 514 may stretch as far as the first arm and the second arm 202a and 202b are away from each other on the clip 200.

As shown in FIGS. 5A-5C, the platform 514 may connect with the first and second clip retaining members 502. In some embodiments, the clip retaining members 502 may be integrally formed with the platform 514. Additionally or alternatively, the clip retaining members may be connected, welded, or otherwise placed in a fixed position relative to the platform 514.

As shown in FIG. 5C, the clip retaining members 502 are substantially perpendicular to the platform 514 where substantially perpendicular may include 15 degrees off a true perpendicular plane relative to the platform 514 in an angular direction.

In some embodiments, the clip retaining members 502 may extend upward to a height just under the slot 206. In some embodiments, by not covering the slot 206, the clip 200 may be configured to slide into position accommodating the frame rail flange 108 and the mounting rail flange 152.

In some embodiments, the clip retaining members 502 may be separated by a distance indicated by dashed line 516. The space defined by the separation between the first and second clip retaining members 502a and 502b may accommodate at least a portion of the clip 200. In some embodiments, the space indicated by the dashed line 516 may be sufficient to accommodate the connecting body 204 of the clip 200 when the clip 200 is positioned between the clip retaining members 502.

The space between the first clip retaining member 502a and the second clip retaining member 502b may be designed to provide a snug fit for the connecting body 204 of the clip 200, which may help to prevent lateral movement of the clip 200 during installation procedures. In some embodiments, this space may be slightly larger than the width of the connecting body 204 to allow for easy insertion and removal of the clip 200 while still providing adequate stability during installation operations.

In some embodiments, the clip retaining members 502 may include one or more internal features, such as ridges, grooves, or textured surfaces, that may enhance the grip on the connecting body 204 of the clip 200. These internal features may be configured to correspond with complementary features on the connecting body 204, which may further secure the clip 200 in place during installation.

The spacing between the clip retaining members 502 may be configured to facilitate the installation of the clip 200 by allowing the clip 200 to be quickly positioned and held in place while the clip installation tool 500 applies a force to secure the clip 200 onto the combination of the mounting rail flange 152 and the frame rail flange 108. The clip retaining members 502 may be designed to hold the clip 200 in an orientation that aligns the slot 206 of the clip 200 with the mounting rail flange 152 and the frame rail flange 108, which may help to ensure proper installation of the clip 200. In some embodiments, the space between the first clip retaining member 502a and the second clip retaining member 502b may be modified to fit one or more other example clips such as, for example, the clips 300 and 400 of FIGS. 3 and 4.

In some embodiments, by forcing the pivot jaw 504 toward the fixed jaw 506, the fixed jaw 506 may press against the clip 200 pushing it further into the space defined by the separation of the clip retaining members 502. In some embodiments, pushing the clip 200 through the retaining members 502 may force together the first and second arms 202a and 202b of the clip 200. As the clip 200 is pushed through the space defined by the first clip retaining member 502a and the second clip retaining member 502b, compression forces to the exterior surfaces of the first and second arms 202a and 202b. In some embodiments, the compression may cause the arms 202a and 202b to move inward toward each other, reducing the distance between the arms 202.

In some embodiments, the inward movement of the first and second arms 202a and 202b may result in the widening of the slot 206. As the arms 202a and 202b are forced closer together, the slot 206 may expand to accommodate the combined thickness of the frame rail flange 108 and the mounting rail flange 152 more easily than in instances where the arms 202 remain in place. In some embodiments, expanding the slot 206 may facilitate smoother insertion of these components during the installation process, reducing the friction that would otherwise occur if the slot 206 remained at its natural width.

Additionally or alternatively, compressing the first and second arms 202a and 202b toward each other may enable the arms 202 to move past the clip retention tabs 170 on the mounting rail 150 with reduced resistance. In instances where the arms 202a and 202b are forced toward each other, their exterior surfaces may clear the clip retention tabs 170a and 170b more readily, allowing for easier positioning of the clip 200 during installation. This compression may temporarily reduce the effective width of the clip 200, permitting the clip 200 to slide into position without being obstructed by the clip retention tabs 170.

The pressure and/or forces for squeezing the arms 202a and 202b together may be generated by the fixed arm 508 of the clip installation tool 500. As the fixed arm 508 pushes the clip 200 through the clip retention members 502, the resistance encountered by the clip 200 may translate into inward force on the first and second arms 202a and 202b. The fixed arm 508 may apply a consistent force that maintains the compression of the arms 202a and 202b throughout the installation process until the clip 200 reaches its intended position.

Once the clip 200 has been fully pushed through the clip retaining members 502 and properly positioned on the mounting rail flange 152 and frame rail flange 108, the compression force applied to the first and second arms 202a and 202b may be released—e.g., using the locking mechanism 520. Upon release, the arms 202a and 202b may naturally spring back outward due to the inherent elasticity of the material of the clip 200. This outward expansion may cause the first and second retention recesses 208a and 208b to engage with the first and second clip retention tabs 170a and 170b, securing the clip 200 in its installed position.

Stated differently, installation of the clip 200 involves three distinct installation states. In a first state or resting state, the clip 200 is in a natural resting position, with the first and second arms 202a and 202b spaced apart without any applied force. In a second state or intermediate state, the clip 200 is compressed by applying force to the first and second arms 202a and 202b, bringing them closer together than in the resting state. The PV clip installation tool 500 may be used to transition the clip 200 into this second state to facilitate passage past the clip retention tabs 170. Upon release, the clip 200 enters a third state or installed state, wherein the first and second arms 202a and 202b engage the clip retention tabs 170. In one or more additional embodiments, the PV clip installation tool 500 may also be configured to install other clips, including, for example, clips 300 and 400 illustrated in FIGS. 3 and 4.

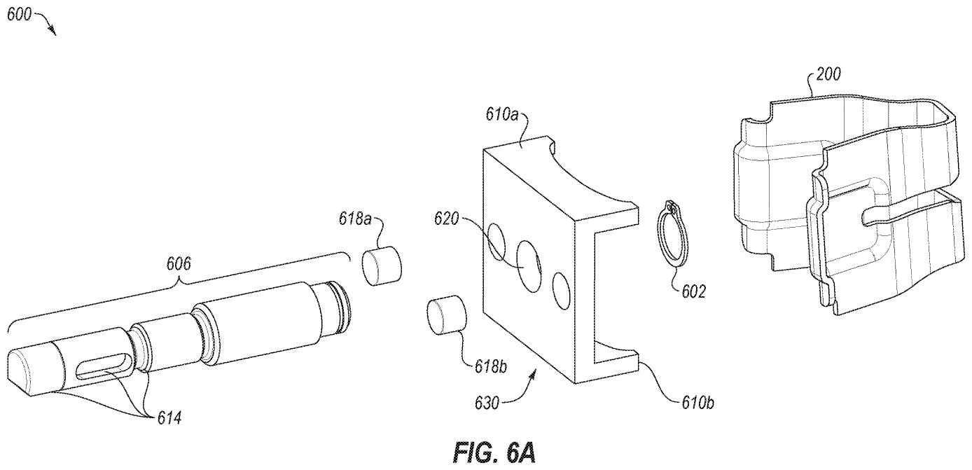

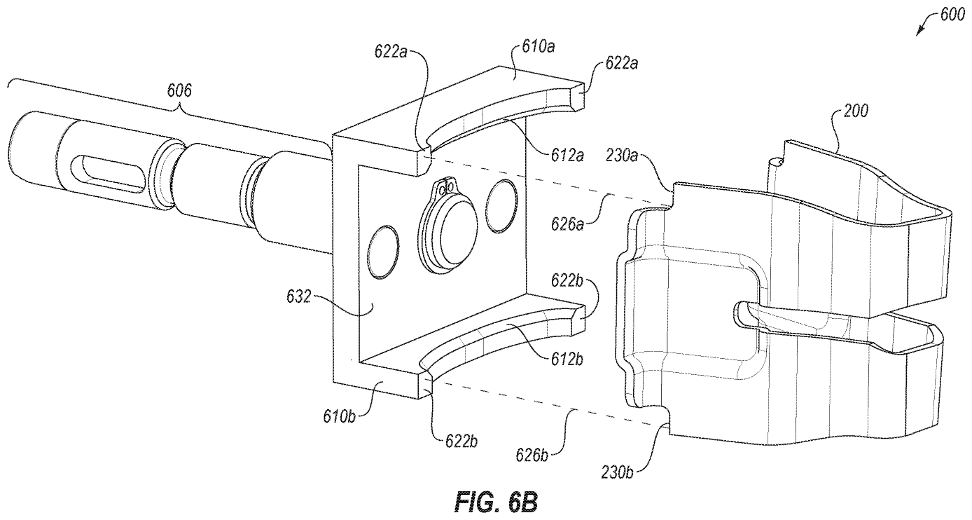

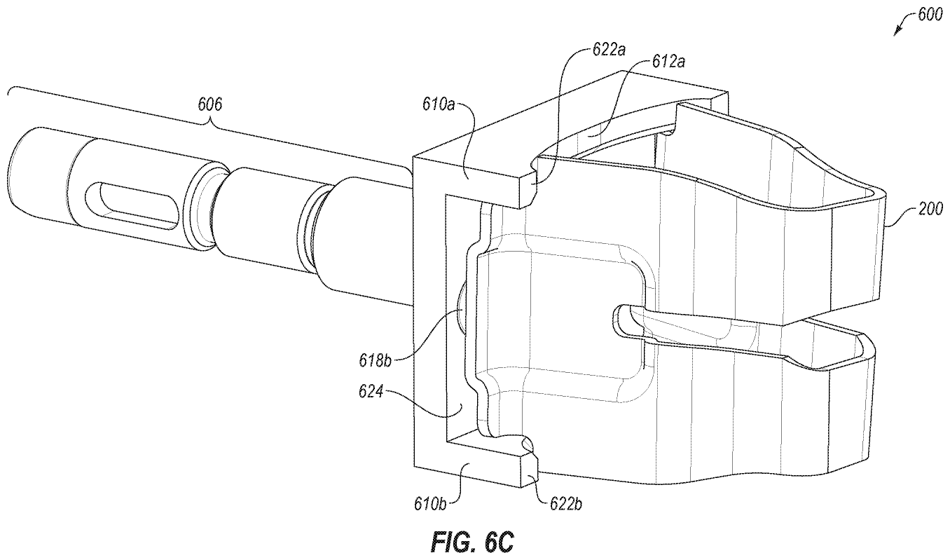

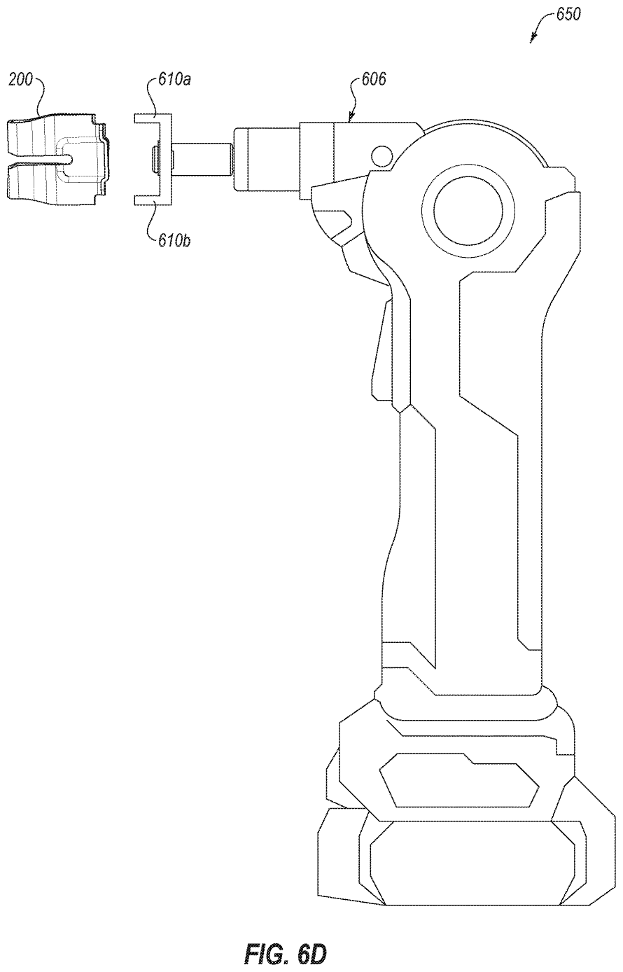

FIGS. 6A-6D illustrate various views of an example embodiment of a PV clip adapter 600 for use in a PV clip installation tool 650 and its interactions with the clip 200 described and/or illustrated with respect to FIGS. 1 and 2. The PV clip installation tool 650 includes one or more mechanisms configured to translate force from one or more impacts to facilitate installation of the clip 200 on the mounting rail flange 152 and the frame rail flange 108. While FIGS. 6A-6D illustrate example embodiments showing the clip 200, the PV clip adapter 600 may be configured to install one or more different clips such as, for example, the clips 300 and 400 of FIGS. 3 and 4.

FIG. 6A illustrates an exploded view of the PV clip adapter 600 for use in a PV clip installation tool—e.g., the PV clip installation tool 650 described and/or illustrated further in the present disclosure such as, for example, with respect to FIG. 6D. The adapter 600 includes a force-transmitting shaft 606 and a clip mount 630.

The force-transmitting shaft 606 may be configured to receive repeated impact forces and to transmit such forces to the clip mount 630 and, ultimately, to the clip 200 in order to perform one or more installation operations. In some embodiments, the force-transmitting shaft 606 may be formed from durable materials, including but not limited to hardened steel, aluminum alloys, or reinforced composite materials, selected for an ability to withstand multiple impact events without significant deformation or structural degradation. As shown in FIGS. 6A-6D, the force-transmitting shaft 606 may include a generally cylindrical body having one or more diameters along a length of the force-transmitting shaft 606, where the thickness or diameters of the force-transmitting shaft 606 are selected to balance structural integrity with weight constraints to facilitate manual handling during installation procedures.

In some embodiments, the force-transmitting shaft 606 may include one or more adapter features 614 that may help facilitate interfacing with one or more impact-generating tools—e.g., one or more impact drivers, rotary hammers, impact drills, hammer drills, among others. In some embodiments, the adapter features 614 may be disposed at one end of the force-transmitting shaft 606 and may be configured to engage with a variety of power tools. In some embodiments, the adapter features 614 may include notches, grooves, or recesses, flat or rounded edges, etc. that may be adapted to mechanically engage corresponding protrusions or locking mechanisms of various impact-generating tools. In some embodiments, the adapter features 614 may be intended to help to secure a connection between the force-transmitting shaft 606 and the tool, even under conditions involving repeated or high-magnitude impact forces.

In some embodiments, the force-transmitting shaft 606 may deliver a force upon actuation of the impact tool toward the clip mount 630. In some embodiments, during installation operations, forces delivered on repeated impact may move the clip 200 from a first position to a second position eventually fully installing the clip 200.

In some embodiments, the shaft 606 may be engineered to increase impact transmission efficiency while decreasing vibrational feedback, and may include one or more damping features to reduce operator fatigue during extended use. The mechanical interface between the shaft 606 and the clip mount 630 may be structurally reinforced or otherwise configured to maintain alignment and integrity over multiple impact cycles.

In some embodiments, the force-transmitting shaft 606 may be connected to the clip mount 630 by inserting the force-transmitting shaft 606 into the aperture 620 and securing the shaft 606 using a ring 602. The ring 602 may provide a secure mechanical connection between the shaft 606 and the clip mount 630, enabling efficient transfer of impact forces from the shaft 606 to the clip mount 630. In some embodiments, the connection between the force-transmitting shaft 606 and the clip mount 630 may be implemented using one or more other structures instead of or in addition to using the ring 602. For example, the connection between the shaft 606 and the clip mount 630 may be implemented using one or more threads, compression fittings, tapered sockets, keyed interfaces, bayonet couplings, detent mechanisms, locking pins, quick-release fasteners, to name a few alternatives.

The clip mount 630 is configured to receive and securely retain the clip 200 during one or more installation procedures. In particular, the clip mount 630 is structurally designed to withstand repeated impact forces that may be transmitted through the force-transmitting shaft 606 during installation. As illustrated in FIGS. 6A-6D, the clip mount 630 includes a base structure 632 and a pair of opposed retaining arms—an upper clip retaining arm 610a and a lower clip retaining arm 610b—collectively referred to as the clip retaining arms 610.

In some embodiments, the clip mount 630—including the base structure 632 and the clip retaining arms 610—is dimensioned to accommodate the geometry of the clip 200. As shown, for example, in FIGS. 6B and 6C, the lateral width of the base structure 632 and the retaining arms 610 exceeds the distance between the first and second arms 202a and 202b of the clip 200. In some embodiments, the width also exceeds the span between the first and second clip flanges 210a and 210b. In some embodiments, by providing a greater width than the corresponding structural elements of the clip 200, the clip mount 630 may facilitate the uniform distribution of force transmitted from the shaft 606, thereby promoting consistent and reliable installation outcomes.

The external surfaces 622 (e.g., 622a and 622b) of the clip mount 630 may represent portions of the clip retention arms 610 that extend around portions of the clip 200 in an installed state. As shown in FIGS. 6A-6D, the external surfaces 622a and 622b may be formed as curved or contoured sections of the clip retention arms 610a and 610b, respectively. These external surfaces 622 may be configured to partially wrap around or envelop corresponding portions of the clip 200 when the clip 200 is positioned within the clip mount 630 for installation.

In some embodiments, the external surfaces 622 may include recessed areas or channels that may be shaped to complement the geometry of the clip 200, particularly the first and second arms 202a and 202b. The contoured shape of the external surfaces 622 may help to cradle the clip 200 securely during installation operations, providing lateral stability that may prevent the clip 200 from shifting or becoming misaligned when impact forces are applied through the force-transmitting shaft 606.

The extension of the external surfaces 622 around portions of the clip 200 may help with precise positioning of the clip 200 relative to the clip mount 630. In some embodiments, the external surfaces 622 may be dimensioned and shaped to engage with specific regions of the clip 200, which may ensure that the clip 200 is consistently aligned in the same or similar orientation for each installation. In some embodiments, consistent positioning may be helpful to properly align the slot 206 of the clip 200 with the mounting rail flange 152 and the frame rail flange 108 during installation procedures.

During installation operations, the external surfaces 622 may also serve to improve stability when the clip 200 is subjected to impact forces. In some embodiments, the wraparound configuration of the external surfaces 622 may help to distribute impact forces more evenly across the structure of the clip 200, which may reduce the risk of damage to the clip 200 during installation. In some embodiments, this distribution of forces may also contribute to more efficient energy transfer from the force-transmitting shaft 606 to the clip 200, potentially decreasing a number of impacts to achieve secure installation.

The configuration of the external surfaces 622 may also provide benefits related to clip retention during transportation or positioning prior to installation. In some embodiments, the external surfaces 622 may be designed with sufficient contact area to hold the clip 200 in place through friction or slight compression, even before impact forces are applied. In some embodiments, the retention capability may allow installers to position the clip installation tool 650 with the clip 200 already in place, potentially improving workflow efficiency during installation operations.

As further illustrated in FIGS. 6A-6D, individual external surfaces 622 corresponding to the clip-retaining arms 610 individually include a beveled edge 612 (e.g., an upper beveled edge 612a and a lower beveled edge 612b). In some embodiments, the beveled edges 612 slope inwardly toward the base structure 632. In some embodiments, the beveled edges 612 are contoured to engage corresponding indentations 230 on the clip 200. For example, the upper beveled edge 612a may be dimensioned to accommodate an upper indentation 230a of the clip 200, while the lower beveled edge 612b may correspondingly receive a lower indentation 230b of the clip 200. In some embodiments, such a configuration may facilitate proper alignment and retention of the clip 200 within the mount 630, thereby reducing the likelihood of misalignment or improper seating during installation of the clip 200.

In some embodiments, the extent to which the upper and lower retaining arms 610 project from the base structure 632 may be determined based on the dimensions and placement of the indentations 230 of the clip 200. Specifically, the arms 610 may extend outward such that, when the indentations 230 are engaged by the retaining arms 610, the clip flanges 210 also make contact with at least a portion of the base structure 632, as shown, for example, in FIG. 6C. In some embodiments, having the clip flanges 210 make contact with the base structure 632 may enhance force distribution across the clip 200 during installation, thereby mitigating the risk of localized stress concentrations and promoting structural integrity under applied loads.

In some embodiments, the clip mount 630 further includes first and second magnets 618a and 618b that may be designed to hold the clip 200 in place relative to the clip mount 630 during installation operations. As shown in FIGS. 6A-6D, the magnets 618 may be included in one or more locations on the base structure 632. The magnets 618a and 618b may be secured within their respective recessed portions using adhesive, press-fitting, or mechanical fasteners to ensure they remain firmly in place during repeated impact operations.

In some embodiments, the magnets 618a and 618b may be constructed from high-strength neodymium or other rare-earth magnetic materials that may provide sufficient magnetic force to securely hold the clip 200 in position. The strength of the magnets 618a and 618b may be selected to balance secure retention of the clip 200 with ease of release after installation.

The positioning of the magnets 618a and 618b within the base structure 632 may be strategically determined to align with ferromagnetic portions of the clip 200. When the clip 200 is placed within the clip mount 630, the magnets 618a and 618b may magnetically engage with the first and second arms 202a and 202b of the clip 200, creating an attractive force that may help to hold the clip 200 in the proper orientation in a pre-installed state.

In some embodiments, the configuration and placement of the magnets 618 may also contribute to proper alignment of the clip 200 within the clip mount 630. By providing magnetic attraction at specific points on the base structure 632, the magnets 618 may help to guide the clip 200 into the correct position for installation, potentially reducing installation errors and improving overall efficiency of the installation process. While the magnets 618 are shown on portions of the base structure 632, the magnets 618 may be positioned at one or more other locations on the clip mount 630 such as, for example, the clip retaining arms 610.

The clip mount 630 and the shaft 606 may be designed for accommodation in one or more tools like the one shown in FIG. 6D. The PV clip installation tool 650 represents an embodiment where the force-transmitting shaft 606 may be coupled to a power tool such as an impact driver or rotary hammer. In this arrangement, the clip mount 630 with its retaining arms 610a and 610b may securely hold the clip 200 during installation operations while the force-transmitting shaft 606 transfers impact energy from the power tool to the clip 200.

In one or more additional embodiments, the PV clip installation tool 650 may also be configured to install other clips, including, for example, clips 300 and 400 illustrated in FIGS. 3 and 4.

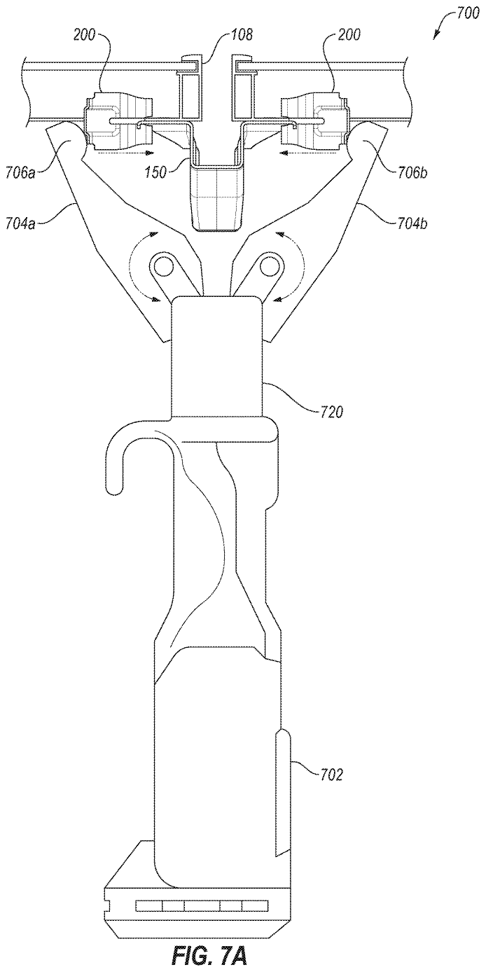

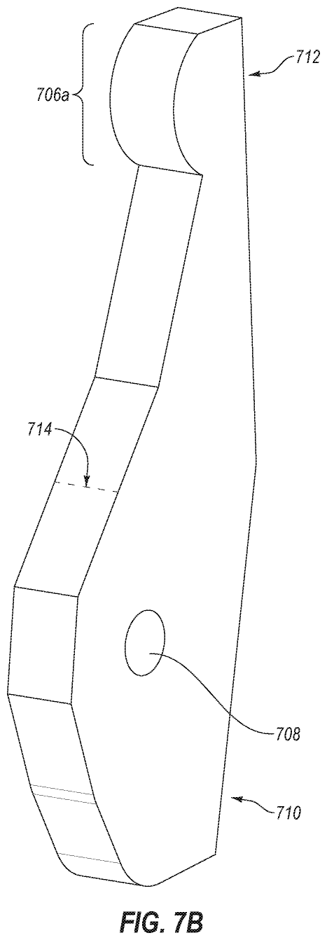

FIGS. 7A and 7B illustrate a clip installation tool 700 including multiple clip attachment arms for attaching multiple PV module clips 200 to a combination of a PV module rail 108 and a mounting rail 150. The PV clip installation tool 700 includes a handle 702, an actuating mechanism 720, a first arm 704a, and a second arm 704b. The handle 702 may be configured to provide a grip for an installer during installation operations. While FIGS. 7A-7B illustrate example embodiments showing the clip 200, the clip installation tool 700 may be configured to install one or more different clips such as, for example, the clips 300 and 400 of FIGS. 3 and 4.

The actuating mechanism 720 may be configured to move in a lateral direction—e.g., forward and backward—to facilitate the installation of clips 200 onto the combination of the mounting rail flange 152 and the frame rail flange 108. In some embodiments, the actuating mechanism 720 may include a sliding component that may translate along a linear path within the handle 702. The actuating mechanism 720 may be mechanically coupled to both the first arm 704a and the second arm 704b, such that linear movement of the actuating mechanism 720 may be converted into rotational movement of the first and second arms 704a and 704b.

In some embodiments, in response to the actuating mechanism 720 moving in a forward direction, the actuating mechanism 720 may apply force to internal linkages connected to the proximal ends of the first arm 704a and the second arm 704b. In some embodiments, the internal linkages may be configured to translate the linear forward motion of the actuating mechanism 720 into outward rotational movement of the arms 704a and 704b. Conversely, in response to the actuating mechanism 720 moving in a backward direction, the internal linkages may cause the first arm 704a and the second arm 704b to rotate inward toward each other.

In some embodiments, converting linear motion of the actuating mechanism 720 to rotational motion of the first and second arms 704a and 704b may be accomplished through a cam-and-follower arrangement, where the actuating mechanism 720 may include one or more cam surfaces that may interact with corresponding follower elements connected to the proximal ends of the first arm 704a and the second arm 704b. In this example embodiment, the actuating mechanism 720 may move forward, the cam surfaces may push against the follower elements, causing the arms 704a and 704b to rotate outward around their respective pivot points.

Additionally or alternatively, the actuating mechanism 720 may include a spring-loaded return feature that may automatically return the actuating mechanism 720 to its starting position after the forward stroke may be completed. This return feature may facilitate rapid sequential installation of multiple clips 200 without requiring the operator to manually reset the tool between installations. The rotational movement of the first arm 704a and the second arm 704b may be calibrated or otherwise determined to apply the appropriate amount of force to push the clips 200 into their installation positions on the mounting rail flange 152 and the frame rail flange 108.

In some embodiments, the actuating mechanism 720 may include one or more mechanical stops to prevent the first and second arms 704a and 704b from over-rotation and potential damage to the clips 200 or the mounting components. Additionally or alternatively, the actuating mechanism 720 may include adjustable settings that may allow the operator to control the amount of force applied during installation, potentially accommodating different clip designs, etc.

In some embodiments, the actuating mechanism 720 may incorporate one or more alternative drive structures capable of producing the desired linear or rotational motion to actuate the arms 704. For example, the actuating mechanism 720 may include an electric motor operatively coupled to a mechanical linkage system, such as a crank or cam arrangement, to convert rotary output into controlled linear displacement. Additionally or alternatively, the actuating mechanism 720 may use a lead screw assembly driven by a motor or manual input to provide precise axial movement along a threaded shaft. As another example, the actuating mechanism 720 may include a solenoid actuator which may generate linear displacement through electromagnetic force. In other embodiments, the actuating mechanism 720 may include fluid-driven systems such as hydraulic or pneumatic cylinders.

In some embodiments, and as shown in FIG. 7A, the first and second arms 704a and 704b each include proximal and distal ends, where the proximal ends of the arms 704 connect to the actuating mechanism 720 and the distal ends connect, receive, and/or otherwise come into contact with respective clips 200. In some embodiments, as the proximal ends of the arms 704 rotate the distal ends may push the clips 200 onto the mounting rail flange 152 and the frame rail flange 108, installing the clips 200.

In some embodiments, the distal end of the first arm 704a includes a first clip mount 706a and the distal end of the second arm 704b includes a second clip mount 706b, where both of the first and the second clip mounts 706a and 706b may be configured to receive and/or retain respective clips 200 during the installation process. As the arms 704a and 704b rotate inward toward each other, the clip mounts 706 may guide the clips 200 into position and apply enough force to engage the clips 200 with the clip retention tabs 170 on the mounting rail 150.

FIG. 7B provides an additional perspective view of an example embodiment of one of the first and second arms 704a and 704b as described and illustrated with respect to FIG. 7A.

The arm 704 includes a proximal end 710 and a distal end 712. In some embodiments, the arm 704 may be wider toward the proximal end 710 and taper to the clip mount 706. In some embodiments, the shape of the arm 704 may be designed to withstand forces used to install the clips 200 repeatedly while also being configured to move freely without hitting the mounting rail 150 during one or more installation operations.

In some embodiments, the arm 704 may include a thickness indicated by dashed line 714, referred to herein as the thickness 714. In some embodiments, the thickness 714 may be uniform along the arm 704. Additionally or alternatively, the thickness 714 may be variable based on the needs of the installation, the force experienced by the arm 704 during installation, etc. For example, in some embodiments, the thickness 714 may be greater closer to the clip mount 706 than the proximal end 710 of the arm 704. In some embodiments, the opposite may be true that the thickness 714 may be greater at the proximal end 710 than at the distal end 712 of the arm 704. In some embodiments, the thickness 714 of the clip mount 706 may be wide enough to connect with the first and second arms 202a and 202b of the clip 200.

In some embodiments, the arm 704 may include one or more connection points 708. For example the connection point 708 may define an aperture that may be configured to receive one or more connecting mechanisms corresponding to the actuating mechanism 720 of FIG. 7A. For example, the connection point 708 may include a pin hole configured to receive a pivot pin that may allow the arm 704 to rotate about the pin when actuated. Additionally or alternatively, the connection point 708 may include a threaded hole that is designed to receive a bolt or screw that may secure the arm 704 to the actuating mechanism 720.

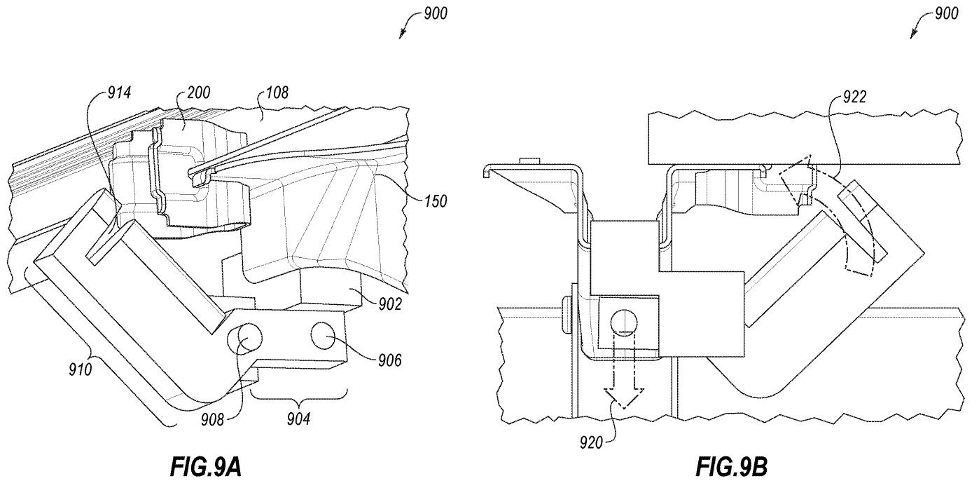

In some embodiments, the clip mount 706 may be configured to attach and/or apply a lateral force to the clips 200. In some embodiments, the thickness 714 of the clip mount 706 may be wide enough to apply a force to the clip flanges 210. Additionally or alternatively, the thickness 714 at the clip mount 706 may be enough to provide a lateral force to one or more other portions of the clip 200 which may facilitate installation of the clip 200. In these or other embodiments, the clip mount 706 may include any number of shapes or mechanisms configured to receive and/or install the clip 200 such as those described in the present disclosure. For example, the clip mount 706 may include the same or similar design to the clip mounts 526, 630, 812, of FIGS. 5A-5C, 6A-6D, FIGS. 8A-8B and/or the clip mounting arm 910 described and/or illustrated further in the present disclosure such as, for example with respect to FIGS. 9A-9B. In one or more additional embodiments, the PV installation tool 700 may also be configured to install other clips, including, for example, clips 300 and 400 illustrated in FIGS. 3 and 4

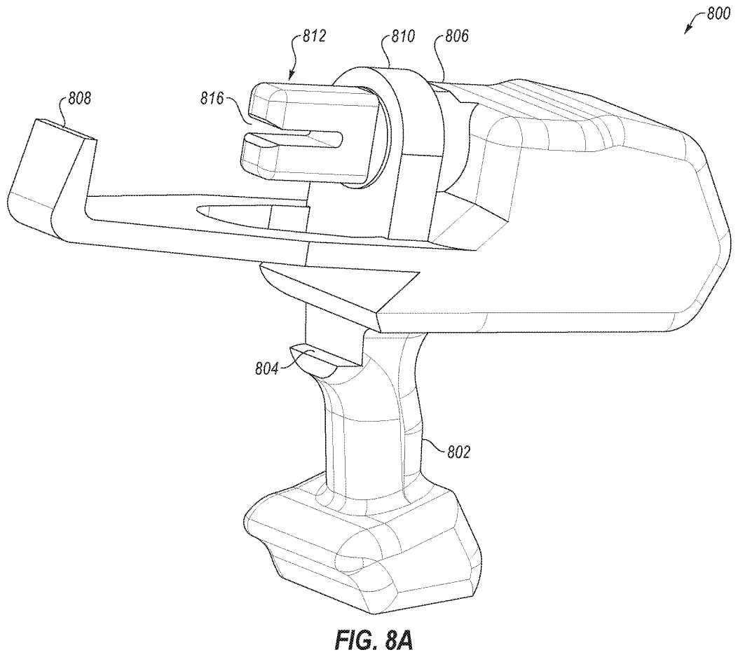

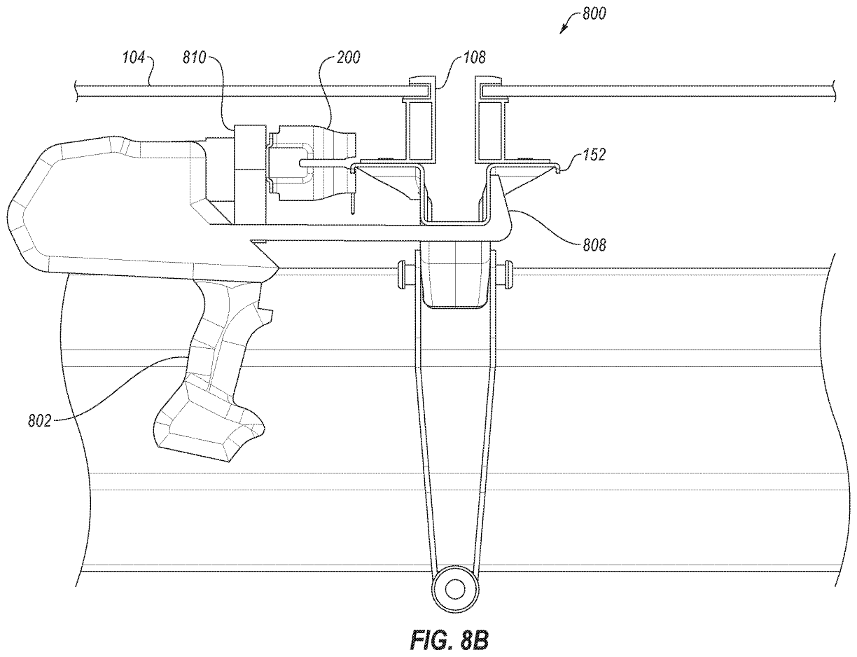

FIGS. 8A and 8B illustrate various views of an example embodiment of a PV clip installation tool 800 that may utilize a drive mechanism 806 for installing the clip 200. As shown in FIG. 8A, the PV clip installation tool 800 may include a housing 802, a trigger mechanism 804, a drive mechanism 806, and a clip mount 812. The housing 802 may be constructed from durable materials such as reinforced plastic, metal, or composite materials that may withstand the operational forces encountered during installation procedures. In some embodiments, the housing 802 may be ergonomically designed to provide comfortable handling and control during extended periods of use. While FIGS. 8A-8B illustrate example embodiments showing the clip 200, the clip installation tool 800 may be configured to install one or more different clips such as, for example, the clips 300 and 400 of FIGS. 3 and 4.

The trigger mechanism 804 may be configured to activate an actuator that may be operatively coupled to a drive mechanism 806. In some embodiments, the drive mechanism 806 may be configured to apply a force to the clip mount 812 to move the clip mount 812 from a first position to a second position, where the second position positions the clip 200 onto a combination of the mounting rail flange 152 and the frame rail flange 108.

In some embodiments, an example drive mechanism 806 may include a linear actuator that may convert rotational motion into linear motion. Continuing the example, the linear actuator may include a leadscrew mechanism where rotation of a threaded shaft may cause linear displacement of the clip mount 812. In response to the trigger mechanism 804 being actuated, the leadscrew may rotate, causing the clip mount 812 to move from the first position to the second position along a linear path. Further, one or more reversing mechanisms may be included in the PV clip installation tool 800 that, in response to being activated, may rotate the leadscrew in an opposite direction thereby causing the clip mount 812 to be moved from, for example, the second position back toward the first position.

Additionally or alternatively, an example drive mechanism 806 may comprise a solenoid-based actuator. In these embodiments, the solenoid may include an electromagnetic coil and a plunger connected to the clip mount 812. In response to the trigger mechanism 804 being actuated, electrical current may flow through the coil, creating a magnetic field that may pull or push the plunger, moving the clip mount 812 from the first position to the second position.

Additionally or alternatively, the drive mechanism 806 may include one or more pneumatic systems—e.g., a pneumatic cylinder system. In examples including the pneumatic cylinder, the system may include a piston connected to the clip mount 812 and a compressed air chamber. In response to the trigger mechanism 804 being actuated, a valve may open, allowing compressed air to force the piston and move the clip mount 812 from the first position to the second position.

Additionally or alternatively, another example drive mechanism 806 may include a cam-driven mechanism. In these embodiments, the cam may be connected to a motor activated by the trigger mechanism 804. In response to rotation of the cam, a follower connected to the clip mount 812 may be moved, converting the rotational motion of the cam into linear motion of the clip mount 812. The shape of the cam profile may be designed to provide variable speed and force during different phases of the installation process.

The clip mount 812 may extend from a base 810. In some embodiments, the base 810 may provide structural support for the clip mount 812 and may be configured to connect to the drive mechanism 806. In some embodiments, the base 810 may include one or more mounting features that may facilitate secure attachment to the drive mechanism 806, which may help to ensure force transfer during installation of the clip 200.

The clip mount 812 may be configured to fit inside the clip 200 to push on the connecting body 204 of the clip 200. In some embodiments, the clip mount 812 may include a profile that corresponds to the interior geometry of the clip 200, particularly the connecting body 204. This corresponding profile may help to align and force distribution during installation of the PV clip 200. In some embodiments, the clip mount 812 may be dimensioned to apply pressure evenly across the connecting body 204, which may help to prevent deformation or damage to the clip 200 during installation.

Additionally or alternatively, the clip mount 812 may include a slot 816 mirroring the slot 206 of the clip 200. In some embodiments, the slot 816 may be aligned with the slot 206 of the clip 200 when the clip 200 is positioned on the clip mount 812. This alignment may allow the clip mount 812 to complete installation of the clip 200 by enabling the combined structure to slide over the mounting rail flange 152 and the frame rail flange 108. In some embodiments, the slot 816 may be slightly wider than the slot 206 to accommodate the combined thickness of the mounting rail flange 152 and the frame rail flange 108 with a decreased amount of resistance.

In some embodiments, the clip mount 812 may be configured to engage with the clip 200 in a manner that may provide stability during installation. The clip mount 812 may include one or more features that may help to center the clip 200 on the clip mount 812, which may ensure proper alignment with the mounting rail flange 152 and the frame rail flange 108. In some embodiments, the clip mount 812 may include one or more retention features that may temporarily secure the clip 200 to the clip mount 812 during positioning and installation.

In response to the clip mount 812 being pushed, the force applied may cause the clip 200 to slide onto the mounting rail flange 152 and the frame rail flange 108. The slot 816 may guide the installation process by ensuring that the slot 206 of the clip 200 remains properly aligned with the mounting rail flange 152 and the frame rail flange 108 throughout the installation procedure. In some embodiments, the clip mount 812 may apply force in a direction that may be substantially perpendicular to the surface of the frame rail flange 108, which may facilitate smooth and efficient installation of the clip 200. In some embodiments, a force reaction arm 808 may be included in the PV clip installation tool 800.

The force reaction arm 808 may be configured to attach to and/or rest on a side of the mounting rail 150 opposite the side where the clip 200 is being installed. In some embodiments, the force reaction arm 808 may provide a counter force to the clip mount 812 during installation operations. In some embodiments, the force reaction arm 808 may include a hooked end portion that may be designed to engage with an underside or edge of the mounting rail 150. This engagement may create a stable anchor point that may resist movement when force is applied to install the clip 200. The hooked configuration may allow the force reaction arm 808 to maintain its position on the mounting rail 150 without requiring additional fasteners or attachment mechanisms.

In some embodiments, the geometry and dimensions of the force reaction arm 808 may be designed to distribute forces evenly across its structure and the mounting rail 150. In some embodiments, the force reaction arm 808 may include a curved or contoured profile that may conform to the shape of the mounting rail 150, increasing contact area and stability and decreasing chances of deformation of the force reaction arm 808 and/or the mounting rail 150.

FIG. 8B provides a detailed view of the installation tool 800 in operation, showing that the clip 200 may be positioned relative to the mounting rail flange 152 and the frame rail flange 108 during installation. As illustrated, the clip mount 812 may hold the clip 200 in the proper orientation for installation, with the slot 206 of the clip 200 aligned with the mounting rail flange 152 and the frame rail flange 108. When the trigger mechanism 804 may be actuated, the drive mechanism 806 may drive the clip mount 812 forward, pushing the clip 200 onto the combination of the mounting rail flange 152 and the frame rail flange 108.

In some embodiments, the installation tool 800 may include additional features such as a depth adjustment mechanism that may allow the user to control the extent to which the clip 200 may be pushed onto the mounting rail flange 152 and the frame rail flange 108. In some embodiments, the depth adjustment mechanism may help to ensure consistent installation results across multiple instances of installing clips 200. Additionally, the installation tool 800 may include a release mechanism that may disengage the clip 200 from the clip mount 812 after installation, allowing for efficient workflow during installation operations.

In an alternative embodiment, the force reaction arm 808 may include a second clip mount 812. This configuration may allow for the simultaneous installation of two clips 200 on opposite sides of the mounting rail 150. The second clip mount 812 may be substantially the same as the first clip mount 812 in structure and function, including the same features for receiving and securing the clip 200 during installation.

The dual clip mount configuration may include a mechanism that may coordinate the movement of both clip mounts 812, ensuring that equal force may be applied to both clips 200 during installation. In some embodiments, the force reaction arm 808 with dual clip mounts 812 may include a central pivot or fulcrum point that may distribute force evenly between the two clip mounts 812, regardless of variations in the applied force.

The second clip mount 812 may be positioned at a distance from the first clip mount 812 that may correspond to the width of the mounting rail 150. In some embodiments, spacing between the first and second clip mounts 812 may be fixed or adjustable to accommodate different mounting rail 150 dimensions. In embodiments with adjustable spacing, the force reaction arm 808 may include telescoping sections, sliding mechanisms, or interchangeable components that may allow installers to customize the tool for specific installation requirements. In some embodiments, the dual clip mount configuration may increase installation efficiency by allowing two clips 200 to be installed in a single operation. In one or more additional embodiments, the PV clip installation tool 800 may also be configured to install other clips, including, for example, clips 300 and 400 illustrated in FIGS. 3 and 4.

Turning to FIGS. 9A and 9B, FIGS. 9A and 9B show various views illustrating an embodiment of a PV clip installation tool 900 and its interactions with the clip 200 described and/or illustrated with respect to FIGS. 1 and 2. The PV clip installation tool 900 may include a mounting body 902, a handle 904 and a clip mounting arm 910. While FIGS. 9A-9B illustrate example embodiments showing the clip 200, the clip installation tool 900 may be configured to install one or more different clips such as, for example, the clips 300 and 400 of FIGS. 3 and 4.

The mounting body 902 may be configured to securely connect the PV clip installation tool 900 to the mounting rail 150 during installation operations. In some embodiments, the mounting body 902 may include one or more channels, slots, or grooves that may be dimensioned to receive an edge of the mounting rail 150. The mounting body 902 may be sized to provide a secure fit when engaged with the mounting rail 150, which may help to stabilize the PV clip installation tool 900 during use.

In some embodiments, the mounting body 902 may be designed with specific dimensions that may ensure proper alignment of the clip mounting arm 910 relative to the mounting rail 150 such that, in instances where the PV clip installation tool 900 may be attached to the mounting rail 150, the clip mounting arm 910 may be positioned at the correct height and orientation for proper installation of the PV clip 200. In some embodiments, the mounting body 902 may include one or more reference surfaces or alignment features that may help to guide the proper positioning of the PV clip installation tool 900 on the mounting rail 150.

In some embodiments, the mounting body 902 may incorporate a clamping mechanism that may provide additional security when attached to the mounting rail 150. In some embodiments, the clamping mechanism may include one or more adjustable components that may be tightened to create friction against the mounting rail 150, which may prevent the installation tool 900 from slipping or shifting during installation operations. In some embodiments, the clamping mechanism may be operated manually through a lever, knob, or other user-accessible control that may allow for quick engagement and disengagement with the mounting rail 150. In some embodiments, the mounting body 902 may be connected to the handle 904 and/or the clip mounting arm 910 using a pin 908.

The handle 904, as shown in FIGS. 9A and 9B, is operatively connected to the clip mounting arm 910, such that movement of the handle 904 may cause movement in the clip mounting arm 910. In some embodiments, the handle 904 may be positioned at an angle relative to a central axis extending through the clip mounting arm 910 such that in instances where a downward force is applied to the handle 904, the downward force causes the clip mounting arm 910 to rotate upward toward the mounting rail flange 152 and the frame rail flange 108.

In some embodiments, the handle 904 may be dimensioned to provide sufficient leverage for rotating the clip mounting arm 910 to install the PV clip 200. In some embodiments, the length of the handle 904 may be designed to balance maneuverability in confined spaces with the mechanical advantage required to overcome resistance during installation of PV clips 200 with an amount of force repeatable by a single installer.

In some embodiments, the handle 904 may define an aperture 906 that may extend partially or completely through a portion of the handle 904. The aperture 906 may be configured with dimensions suitable to receive one or more tools (e.g., one or more cylindrical tools) that may provide additional leverage when pulling on the handle 904. In some embodiments, the aperture 906 may have a circular, oval, or polygonal cross-section that may accommodate various tool types such as screwdrivers, hex keys, or specialized installation rods. The aperture 906 may be strategically positioned along the length of the handle 904 to increase the mechanical advantage provided by any inserted tool, potentially reducing the physical effort required from installers during repetitive installation procedures.

In some embodiments, the pin 908 that may connect the mounting body 902 with the handle 904 and/or the clip mounting arm 910 may be placed along an axis between the handle 904 and the mounting clip arm 910. The pin 908 may be the structure around which the handle 904 and the clip mounting arm 910 rotate. In some embodiments, the pin 908 may be fabricated from one or more durable materials, such as hardened steel, stainless steel, or other wear-resistant metal alloys, selected to withstand repeated application of torsional forces during clip installation operations.

The clip mounting arm 910 may be configured to rotate in response to a downward force applied to the handle 904. As shown in FIGS. 9A and 9B, the clip mounting arm 910 may be mechanically coupled to the handle 904 such that when a downward force is applied to the handle 904, the clip mounting arm 910 may rotate upward in a direction toward the mounting rail flange 152 and the frame rail flange 108. This rotational movement may be facilitated by the pin 908 which may serve as a pivot point around which both the handle 904 and the clip mounting arm 910 may rotate.

The clip mounting arm 910 may include a portion that fits inside the clip 200. In some embodiments, this portion may be dimensioned to provide a snug fit within the clip 200, which may help to prevent the clip 200 from shifting during installation operations.

In some embodiments, the clip mounting arm 910 may include one or more magnets or magnetic materials that may help to hold the clip 200 in place during installation. In some embodiments, the magnets may be positioned on the clip mounting arm 910 to interact with corresponding ferromagnetic portions of the clip 200, creating an attractive force that may help to secure the clip 200 to the clip mounting arm 910. In some embodiments, the magnets may allow an installer to align the PV clip installation tool 900 without having to manually hold the clip 200 in place.

Additionally or alternatively, the clip mounting arm 910 may include a slot 914 that may be designed to mirror the slot in the clip 200. This mirrored slot configuration may allow the clip mounting arm 910 to fully rotate to install the clip 200 onto the mounting rail flange 152 and the PV frame rail flange 108. The slot 914 in the clip mounting arm 910 may be dimensioned to accommodate the combined thickness of the mounting rail flange 152 and the frame rail flange 108, which may ensure that the clip mounting arm 910 may rotate freely during installation.

In some embodiments, the slot 914 may extend along a portion of the clip mounting arm 910 that corresponds to the location of the slot 206 in the clip 200 when the clip 200 is positioned on the clip mounting arm 910. In some embodiments, aligning the slot 914 of the clip mounting arm 910 with the slot 206 of the clip 200 may simultaneously accommodate the mounting rail flange 152 and the frame rail flange 108.

FIG. 9B illustrates the manual PV clip installation tool 900 in operation during the installation of the clip 200. As shown in the figure, a downward force may be applied to the handle 904 as indicated by arrow 920. This downward movement of the handle 904 may cause the clip mounting arm 910 to rotate in the direction indicated by arrow 922. The rotational movement of the clip mounting arm 910 may push the clip 200 onto the combination of the mounting rail flange 152 and the frame rail flange 108. In some embodiments, the rotational movement of the clip mounting arm 910 may be facilitated by the handle 904, which may serve as a fulcrum for the manual PV clip installation tool 900. The mounting body 902 may remain attached to the mounting rail 150 during this operation, providing stability and proper alignment for the installation process.

In some embodiments, the downward force applied to the handle 904 may be translated through the pin 908 into a horizontal force that may push the clip 200 onto the mounting rail flange 152 and the frame rail flange 108. This mechanical advantage provided by the lever action of the handle 904 and the pin 908 may reduce the amount of force required from the installer to secure the clip 200 in place. The clip mounting arm 910 may guide the clip 200 during installation, ensuring that the clip 200 engages properly with the clip retention tabs 170 on the mounting rail 150.

Once the clip 200 has been fully installed, the manual PV clip installation tool 900 may be disengaged from the mounting rail 150 and repositioned for the installation of additional clips 200. The design of the manual PV clip installation tool 900 may allow for rapid sequential installation of multiple clips 200, thereby increasing the efficiency of the installation process for PV modules on mounting rails. In one or more additional embodiments, the PV clip installation tool 900 may also be configured to install other clips, including, for example, clips 300 and 400 illustrated in FIGS. 3 and 4.

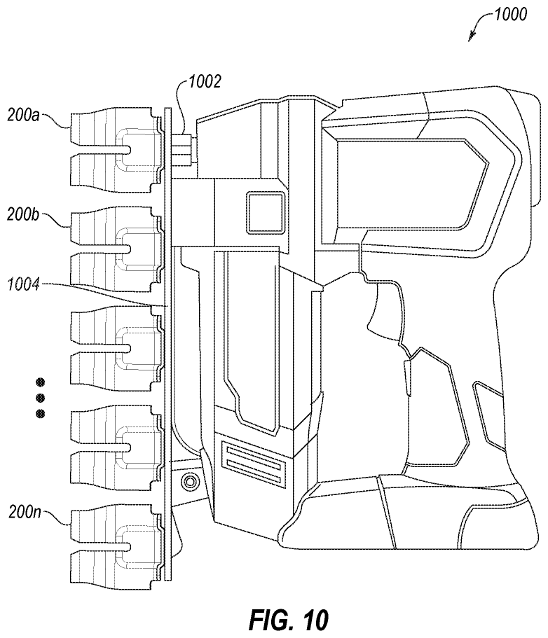

FIG. 10 illustrates an embodiment of a PV clip installation tool 1000 configured to install multiple clips 200 sequentially from a strip 1004. The strip 1004 may include a series of clips 200 arranged in sequence, including a first clip 200a, a second clip 200b, up to an including an nth clip 200n that may be installed in succession. In some embodiments, the strip 1004 may be configured to hold the clips 200 in a predetermined orientation that may facilitate rapid and consistent installation of multiple clips 200 during installation operations. While FIG. 10 illustrates an example embodiments showing the clip 200, the clip installation tool 1000 may be configured to install one or more different clips such as, for example, the clips 300 and 400 of FIGS. 3 and 4.

The installation tool 1000 may be configured to access the strip 1004 and engage with individual clips 200 for installation. In some embodiments, the tool 1000 may be designed to install a first clip 200a onto the combination of the mounting rail flange 152 and the frame rail flange 108, then automatically advance to engage and install a second clip 200b, and continue this process for subsequent clips on the strip 1004. This sequential installation capability may significantly increase installation efficiency compared to handling and installing individual clips 200 separately.

In some embodiments, the strip 1004 may include a flexible or rigid carrier that may hold multiple clips 200 in a predetermined spacing pattern that may correspond to the required spacing of clips 200 along the mounting rail 150. The clips 200 may be temporarily secured to the strip 1004 using various retention mechanisms such as friction fit, adhesive, tabs, and/or other mechanical connections that may allow for easy release when the clips 200 are installed.

The installation tool 1000 may include a feeding mechanism that may advance the strip 1004 after each clip 200 installation, positioning the next clip for installation. In some embodiments, this feeding mechanism may be manually operated, where the installer may advance the strip 1004 after each installation. Additionally or alternatively, the feeding mechanism may be automatically actuated after each installation, potentially further increasing installation efficiency.

The strip 1004 of clips 200 may be supplied in various configurations, such as in rolls, cartridges, or linear strips, depending on the specific requirements of the installation process and the design of the installation tool 1000.

In some embodiments, the clips 200 may be installed using a clip mount 1002. The clip mount 1002 may include one or more different design configurations that may be designed to receive and/or attach to the clips 200. For example, the clip mount may include one or more of other clip mount designs described and/or illustrated in the present disclosure such as, for example, the clip mounts 526, 630, 812, of FIGS. 5A-5C, 6A-6D, FIGS. 8A-8B and/or the clip mounting arm 910 described and/or illustrated further in the present disclosure such as, for example with respect to FIGS. 9A-9B.

In some embodiments, the PV installation tool of FIG. 10 may be implemented using different tools that may be adapted or modified to handle the strip 1004 of clips 200. A pneumatic nail gun may be modified to serve as the PV clip installation tool 1000. In such an implementation, the pneumatic mechanism that typically drives nails may be reconfigured to apply force to the clip mount 1002, pushing clips 200 from the strip 1004 onto the mounting rail flange 152 and frame rail flange 108. The pneumatic pressure system may provide consistent force delivery for each installation operation, while the sequential feeding mechanism typically used for nails may be adapted to advance the strip 1004 after each clip 200 installation.

A battery-powered staple gun may also be modified to serve as the PV clip installation tool 1000. The stapling mechanism may be reconfigured to engage with the clips 200 on the strip 1004, while the feeding system that typically advances staples may be adapted to move the strip 1004 forward after each installation. The battery-powered operation may provide portability advantages for installation crews working in various locations on a solar array.

Each of tool may incorporate the clip mount 1002 design to properly engage with clips 200 during installation, while leveraging existing mechanical systems for force application and sequential feeding to improve installation efficiency compared to manual methods.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

1. An apparatus for facilitating installation of components in a photovoltaic (PV) system, the apparatus comprising:
a clip mount configured to selectively retain a PV module clip; and
a drive mechanism connected to the clip mount, the drive mechanism configured to generate and apply a force to the clip to mount move the clip mount from a first position in which the PV module clip is in an uninstalled state to a second position in which the PV module clip is in an installed state.

2. The apparatus of claim 1, wherein the drive mechanism includes a fluid driven system.

3. The apparatus of claim 2, wherein the fluid driven system is a hydraulic or pneumatic system.

4. The apparatus of claim 1, wherein the drive mechanism includes an electrically driven system.

5. The apparatus of claim 4, wherein the electric driven system is an electric motor.

6. The apparatus of claim 1, wherein the drive mechanism includes a mechanically driven system.

7. The apparatus of claim 1, wherein the force is applied to the clip mount by the drive mechanism through a linear actuator.

8. The apparatus of claim 1, wherein the force is applied to the clip mount by the drive mechanism through a solenoid-based actuator.

9. The apparatus of claim 1, wherein the clip mount is configured to selectively retain the PV module clip through a friction or magnetic attachment.

10. The apparatus of claim 1, further comprising an elongated shaft configured to transmit the force from the drive mechanism to the clip mount.

11. The apparatus of claim 1, further comprising:
a first actuator for activating the drive mechanism to move the clip mount from the first position to the second position; and
a second actuator for activating the drive mechanism to move the PV module clip from the second position to the first position.

12. The apparatus of claim 1, wherein the clip mount has an external shape that corresponds to an interior geometry of the PV module clip.

13. The apparatus of claim 12, wherein the clip mount defines a slot configured to receive one or more components of the PV system during an installation operation.

14. The apparatus of claim 1, further comprising a force reaction arm configured to provide a counter force to the force applied to the clip mount during an installation operation.

15. The apparatus of claim 14, wherein:
the clip mount is a first clip mount; and
the force reaction arm includes a second clip mount configured to selectively retain a second PV module clip.

16. The apparatus of claim 15, wherein a distance between the first and second clip mounts is selectively adjustable.

17. The apparatus of claim 1, wherein the clip mount includes a strip configured to selectively retain a plurality of PV module clips.

18. The apparatus of claim 17, wherein the clip mount includes a feeding mechanism that automatically advances the PV module clips within the plurality of PV module clips after installation operations.

19. An apparatus for facilitating installation of components in a photovoltaic (PV) system, the apparatus comprising:
an impact tool configured to generate repeated impact forces, the impact tool including at least one of a rotary hammer, a percussion mechanism, a solenoid impact mechanism, a cam-based impact mechanism, a spring-loaded impact mechanism, a hydraulic impact mechanism, or a pneumatic impact mechanism;
a clip mount configured to selectively retain a PV module clip; and
a force transmitting shaft configured to transmit the impact forces from the impact tool to the clip mount to move the clip mount from a first position in which the PV module clip is in an uninstalled state to a second position in which the PV module clip is in an installed state.

20. An apparatus for facilitating installation of components in a photovoltaic (PV) system, the apparatus comprising:
a clip mount configured to selectively retain a PV module clip;
a drive mechanism configured to generate and apply a linear force to the clip mount, wherein the drive mechanism comprises a pneumatic, hydraulic, or electric motor; and
a force reaction arm configured to provide a counter force to the linear force applied to the clip mount during an installation operation.
